(19) United States
(12) Patent Application Publication
(10) Pub. No.: US 2024/0181536 A1
(43) Pub. Date: Jun. 6, 2024

(54) METHOD AND APPARATUS FOR OFFSETTING REFLECTED LIGHT ENERGY IN ADDITIVE MANUFACTURING SYSTEM

(71) Applicant: VulcanForms Inc., Burlington, MA (US)

(72) Inventor: Michael von Dadelszen, Merrimack, NH (US)

(73) Assignee: VulcanForms Inc., Burlington, MA (US)

(21) Appl. No.: 18/524,074

(22) Filed: Nov. 30, 2023

Related U.S. Application Data
(60) Provisional application No. 63/429,217, filed on Dec. 1, 2022.

(51) Int. Cl. B22F 12/49; B22F 10/28; B22F 12/45; B33Y 10/00; B33Y 30/00; B33Y 80/00

(52) U.S. Cl. CPC B22F 12/49; B22F 10/28; B22F 12/45; B33Y 10/00; B33Y 30/00; B33Y 80/00; B22F 2998/10

(57) ABSTRACT

Light energy directed toward a build surface can be deflected by a deflection optical element at a location and at an angle suitable to offset light energy reflected by a melt pool at the build surface from the location. The reflected light energy can be offset a distance to prevent the reflected light energy from traveling a coincident path of incident light energy and to cause the reflected light energy to be received by a light absorbing element.

### RELATED APPLICATION

This application claims priority under 35 U.S.C. § 119(e) to U.S. Provisional Application No. 63/429,217, filed Dec. 1, 2022, the content of which is incorporated by reference in its entirety for all purposes.

### FIELD

Disclosed embodiments are generally related to optical systems for additive manufacturing.

### BACKGROUND

Additive manufacturing systems employ various techniques to create three-dimensional objects from two-dimensional layers of precursor material. In general, a layer of precursor material may be deposited onto a build surface, and selected portions of the layer may be fused through exposure to one or more energy sources to create a desired two-dimensional geometry of solidified material within the layer. One or more layers of precursor material may subsequently be provided one over the other, and selected portions of each layer fused together and to the layer below to generate a desired three-dimensional structure.

### SUMMARY

Some additive manufacturing processes involve the melting or other liquification of a metal or other powder precursor material to form a melt pool. Such melt pools fuse the precursor material in desired areas to form the desired two-dimensional structure for a given layer, and thus a three-dimensional structure when the fused portions of different layers are joined together. Melt pools can be formed by exposing the precursor material to laser or other light energy of sufficient power to melt the precursor material in a local area. In some cases, melt pools can be highly reflective of light energy, e.g., a pool of liquid aluminum alloy can be highly reflective of light energy over a relatively wide wavelength range, including the wavelength(s) used to melt the precursor material in the first instance. As an example, a high energy laser beam can be used to melt precursor material to form a melt pool and that melt pool can operate to reflect at least some of the laser light back toward the optical system used to generate the laser beam. In some cases, it has been found that a melt pool can reflect up to 20-30% of laser light used to form the melt pool, and there is a risk that reflected light can cause damage to optical and/or other components of the additive manufacturing apparatus.

Aspects of the disclosure provide systems and methods for operating on light energy, such as one or more laser beams, used to melt or otherwise liquify a precursor material on a build surface such that light energy reflected by one or more melt pools formed by the light energy is offset from an optical system location. This offset can help avoid heating, damage and/or other effect on optical system components, such as lenses used to form and direct a laser beam as well as laser light generators. In some cases, reflected light energy can be offset from the optical system location and directed to a beam block or other light energy absorbing element that is configured to receive the reflected light energy and protect other optical system components from the reflected light energy. As an example, reflected light energy can be offset so that the reflected light energy cannot travel along a light path that a laser beam or other light energy incident on the build surface travels through the optical system on its way to the build surface. This can help protect light energy sources, such as laser generators, as well as other optical components from the reflected light energy. These features may be particularly important with relatively high power laser systems that employ laser light with a power of up to 100 kW or more.

In some embodiments, an optical system for an additive manufacturing apparatus includes a light energy source configured to provide light energy with a power sufficient to melt a metal powder material. For example, one or more laser generators may provide laser light energy for direction to a build surface to melt a metal powder or other precursor material. A plurality of optical elements may be configured to receive the light energy from the light energy source and direct the light energy toward a build surface supporting the metal powder material to melt a portion of the metal powder material and form a melt pool. For example, the optical elements may include lenses, mirrors, apertures, and/or any other suitable optical elements to operate on the light energy and direct the energy toward a build surface, e.g., in a direction perpendicular to a plane of the build surface. A deflection optical element may be configured to operate on the light energy from the plurality of optical elements to deflect the light energy directed toward the build surface at a location and at an angle suitable to cause light energy reflected by the melt pool toward the deflection optical element to be offset from the location. Such deflection may be suitable to prevent reflected light energy from traveling a same path that incident light energy travels to the build surface, and thus may help protect optical components or other system parts from the reflected light energy. In some cases, the deflection optical clement may be a static element with an invariable effect on the light energy from the plurality of optical elements. For example, the deflection optical element may be a prism that is not movable relative to light energy incident on the prism. In some embodiments, the deflection optical clement is a prism with a planar input surface that receives the light energy from the plurality of optical elements and a planar output surface that directs the light energy toward the build surface. The planar input surface may be arranged at an angle of 1 degree to 10 degrees relative to the planar output surface, and/or the planar input surface may be arranged perpendicular to a direction along which the light energy from the plurality of optical elements is incident on the planar input surface. In some cases, the deflection optical element may be a terminal optical element of the optical system before the light energy is incident on the build surface, e.g., the deflection optical element may have no other optical components between it and the build surface. In some cases, the deflection optical clement may be optically upstream of a debris shield, e.g., the debris shield may be positioned between the deflection optical element and the build surface to protect the deflection optical element from fusion products generated during the precursor material fusion process.

In some embodiments, the deflection optical element may deflect the light energy directed toward the build surface such that light energy reflected by the melt pool is offset by a distance of 5 mm to 30 mm from the location, e.g., the location where the deflection optical element deflects the incident light energy. This offset distance may be suitable to prevent reflected light energy from traveling into a light path of the optical system. In some cases, the plurality of optical elements may be configured to direct the light energy toward the build surface in a direction perpendicular to the build surface prior to the light energy being deflected by the deflection optical element, and the deflection optical element may deflect the light energy directed toward the build surface at an angle of 0.5 degree to 15 degrees, e.g., 1 degree to 8 degrees. In some embodiments, the deflection optical element may be configured to transmit the reflected light energy through the deflection optical element and toward a light energy absorbing component, e.g., a beam block configured to shield the reflected light energy from the plurality of optical elements.

The deflection optical element may be configured to operate on one or more light beams, e.g., laser beams, that are directed by the plurality of optical elements toward the build surface, and one or more deflection optical elements may be provided to deflect one or more light beams. For example, in some embodiments, the light energy source and the plurality of optical elements may be configured to direct a plurality of laser beams toward the build surface to form a plurality of melt pools, and one or more deflection optical elements may be configured to deflect the plurality of laser beams at respective locations and at respective angles suitable to cause light energy reflected by the plurality of melt pools toward the deflection optical element to be offset from the locations.

In some embodiments, a method of managing light energy for an additive manufacturing process includes providing light energy with a power sufficient to melt a metal powder material, and using a plurality of optical elements to receive and operate on the light energy to direct the light energy toward a build surface supporting the metal powder material to melt a portion of the metal powder material and form a melt pool. Light energy from the plurality of optical elements directed toward the build surface may be deflected at a location and at an angle suitable to cause light energy reflected by the melt pool toward the plurality of optical elements to be offset from the location. For example, the light energy may be directed toward the build surface in a direction perpendicular to the build surface, and may be deflected at an angle of 0.5 degree to 15 degrees. In some cases, deflecting the light energy directed toward the build surface may cause light energy reflected by the melt pool to be offset by a distance of 5 mm to 30 mm from the location where the incident light energy is deflected. This may cause the reflected light energy to be absorbed or otherwise operated on by a beam block or other component that helps protect other optical components from the reflected light energy. In some embodiments, a static element with an invariable effect on the light energy is used to deflect the light energy from the plurality of optical elements. For example, the light energy directed toward the build surface can be received at a planar input surface of a prism and output from a planar output surface of the prism toward the build surface, where the planar input surface is arranged at an angle of 1 degree to 10 degrees relative to the planar output surface. In some embodiments, a plurality of laser beams may be directed toward the build surface by the plurality of optical elements to form a plurality of melt pools, and the plurality of laser beams may be deflected at respective locations and at respective angles suitable to cause light energy reflected by the plurality of melt pools toward the plurality of optical elements to be offset from the locations.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material (e.g., metal powder material or other appropriate powder material) deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

Other advantages and novel features of the present disclosure will become apparent from the following detailed description of various non-limiting embodiments of the disclosure when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows an embodiment of an additive manufacturing system;

FIG. 2 shows a schematic view of light energy directed from a light energy source and optical system toward a build surface and reflected light energy from a melt pool at the build surface directed back toward the optical system along a same path as the incident light energy; and

FIG. 3 shows a schematic view of light energy directed from a light energy source and optical system toward a build surface that is deflected such that reflected light energy from a melt pool is offset from the incident light energy at the deflection location.

### DETAILED DESCRIPTION

Inventive features are described below with reference to illustrative embodiments, but it should be understood that inventive features are not to be construed narrowly in view of the specific embodiments described. Thus, aspects of the invention are not limited to the embodiments described herein. It should also be understood that various inventive features may be used alone and/or in any suitable combination with each other, and thus various embodiments should not be interpreted as requiring any particular combination or combinations of features. Instead, one or more features of the embodiments described may be combined with any other suitable features of other embodiments.

As noted above, inventive features provide for offsetting reflected energy from a build surface in an additive manufacturing system from a location of an optical system, e.g., so that the reflected light energy is not incident on or near optical components that are sensitive to the reflected light energy. For example, additive manufacturing systems that employ laser power of up to 100 kW or more risk damaging or otherwise affecting components of the system with light energy reflected by melt pool(s) formed by the laser energy at the build surface. Melt pools can reflect up to 20-30% of light energy used to form the melt pool, and the reflected light energy can be directed back along the optical path of the laser beam or other incident light energy. This can cause heating or other effects on optical and other components exposed to the reflected light energy, such as vaporization of epoxies, glues and other non-metallic materials, as well as vaporization of metal components in some circumstances. Vaporized materials can be deposited on optical components, affecting their ability to properly focus or otherwise operate on light energy, as well as have other potentially harmful effects. Operating on incident light energy directed to a build surface so that light energy reflected by melt pools at the build surface are offset from a location of the optical system, such as an incident light beam path, can help avoid such problems.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material (e.g., metal powder material or other appropriate powder material) deposited onto the build surface to form the one or more parts. This may be performed in a sequential manner where each layer of precursor material (e.g., metal powder material or other appropriate powder material) is deposited on the build surface and selected portions of the upper most layer of precursor material (e.g., metal powder material or other appropriate powder material) is fused to form the individual layers of the one or more parts. This process may be continued until the one or more parts are fully formed.

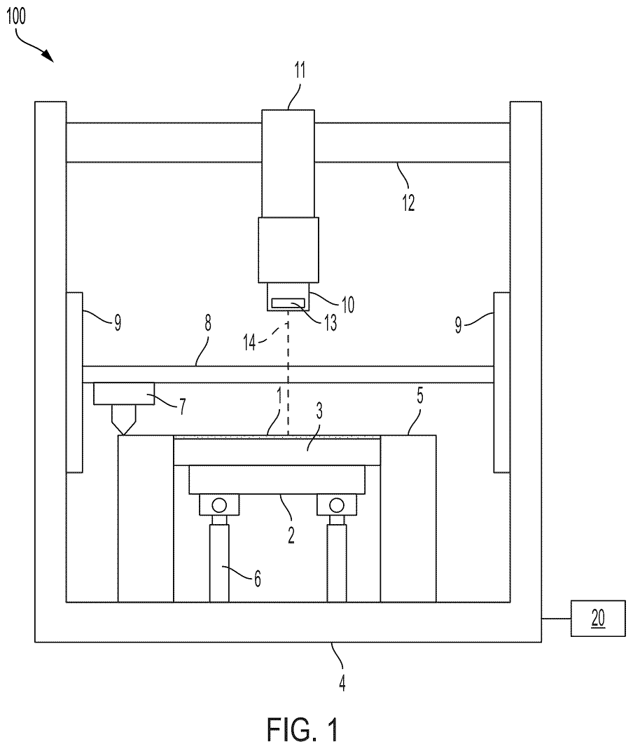

To help illustrate some of the problems that may be caused by reflected light energy from a build surface, FIG. 1 shows a schematic diagram of an additive manufacturing system 100, including one or more light energy sources 11, such as a plurality of laser energy generators, that provide light energy to an optics assembly 10. As will be understood by those of skill in the art, light energy can be provided to the optics assembly 10 in any suitable way, such as by optical fiber, transmission through air or other gas, etc. Likewise, the optics assembly 10 can include any suitable components such as refractive and/or reflective optical elements such as lenses, apertures, collimators, couplers, etc. as well as other non-optical components such as shields, stray light absorbing elements, heat sinks, actuators to move optical elements and/or other system components, etc. In short, the light energy source 11 and the optics assembly 10 can include any suitable components to define an optical path and to generate, transform, shape, and/or direct light energy, e.g., one or more laser beams, spots or other light energy arrangements 14, toward a build surface 1 of the system 100. As will also be understood, the light energy can be controlled so that selected areas of the build surface 1 are exposed to a desired amount of light energy to fuse precursor material at the build surface 1. Thus, the optics assembly 10 can be configured to control the incident light energy 14 to provide an array of one or more laser energy pixels at the build surface 1 to selectively fuse (or not) precursor material at each pixel. Continuous or discrete portions of the precursor material can be fused to form any desired pattern of fused material. In some cases, the optics assembly 10 can be configured to scan or otherwise move laser beams or other light energy rays relative to the build surface 1, e.g., using galvomirrors or other movable mirrors or other controllable reflective and/or refractive elements. Alternately, or in addition, the optics assembly 10 or a portion of it that emits the incident light energy 14 can be moved relative to the build surface 1, e.g., via a gantry, robotic system, rails, drive motors, or other optics assembly drive 12, to create a desired two-dimensional pattern of fused precursor material at the build surface 1.

The build surface 1 can be supported by a build plate 3 mounted on a fixed plate 2, which is in turn mounted on one or more vertical supports 6. The one or more vertical supports 6 can move the build plate 3 vertically and/or in other directions, e.g., to level or otherwise orient the build surface 1 in a desired way. A powder containment shroud 5 may at least partially, and in some embodiments completely, surround a perimeter of the build plate 3 to support a volume of precursor material, such as a volume of powder, disposed on the build plate 3. The system 100 can include a powder deposition system, e.g., including a hopper and/or recoater 7 mounted on a horizontal motion stage 8 that allows the hopper and/or recoater to be moved across all or a portion of the build surface 1. The hopper and/or recoater 7 can operate to deposit and spread a precursor material onto the build surface 1 to provide a layer of precursor material with a predetermined thickness on top of the underlying volume of fused and/or unfused precursor material deposited during prior formation steps. In some embodiments, the hopper and/or recoater 7 may be held vertically stationary for dispensing and spreading precursor material onto the build surface 1 and the build surface 1 can be moved vertically by the vertical supports 6. In some cases, the hopper and/or recoater 7 can be moved vertically relative to the build surface 1 by a vertical motion stage 9 and the build surface 1 can be held stationary.

In addition to the above, in some embodiments, the depicted additive manufacturing system may include one or more controllers 20 that is operatively coupled to the various actively controlled components of the additive manufacturing system. For example, the one or more controllers may be operatively coupled to the one or more supports 6, hopper/recoater 7, optics assembly 10, the various motion stages, and/or any other appropriate component of the system. In some embodiments, the controller 20 may include one or more processors and associated non-transitory computer readable memory. The non-transitory computer readable memory may include processor executable instructions that when executed by the one or more processors cause the additive manufacturing system to perform any of the methods disclosed herein.

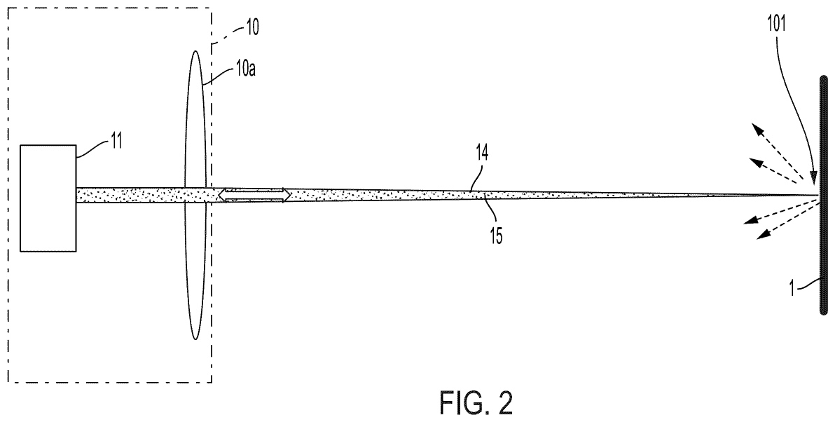

In some embodiments, an optics assembly 10 can be configured to direct laser or other light energy in a direction that is perpendicular to a build surface. As an example, FIG. 2 shows a schematic arrangement in which an optics assembly 10 is configured to generate and direct one or more laser beams or other light energy along a path that is perpendicular to a build surface 1. This incident light energy 14 may heat and melt precursor material on the build surface to form a melt pool 101 so that portions of the precursor material are fused in discrete and/or continuous regions of the build surface 1. However, the melt pool 101 may reflect light energy along a reflected light energy path 15 that is coincident with or otherwise substantially along the incident light energy path 14. This can permit the reflected light energy 15 to enter the optics assembly 10, at least in part. Thus, the reflected light energy 15 can be incident on one or more optical components 10a of the optics assembly 10, such as lenses, apertures, mirrors, debris shields, beam blocks, etc., and/or on one or more portions of the light energy source 11. In some cases, the reflected light energy 15 can heat portions of the optics assembly 10 or light energy source 11 in undesired ways or have other undesirable affects. For example, the reflected light energy 15 can have affects such as vaporizing adhesives, metals or other materials in the optics assembly 10 or light energy source 11, excessively heating components, which can cause undesired effects on incident light energy generation and transmission in the optics assembly 10, and others.

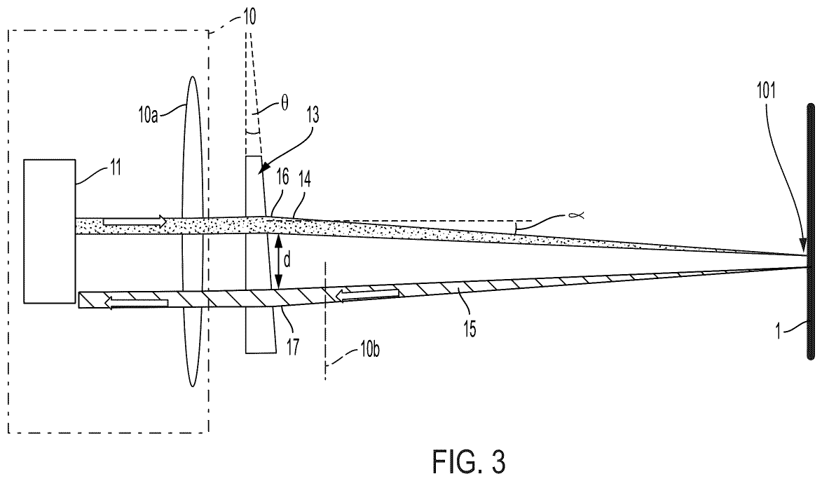

In some embodiments, incident light energy can be operated on such that reflected light energy from the build surface is offset from a location of at least a portion of the optics assembly. This offset of the reflected light energy relative to the location of a portion of the optics assembly can prevent the reflected light energy from being incident on portions of the optics assembly and/or the light energy source in undesired ways. As an example, incident light energy can be deflected by an optical element at a location and at an angle suitable to cause light energy reflected by a melt pool back toward the optical element to be offset from the location where the optical element deflects the incident light energy. As such, the reflected light energy can be prevented from traveling along a same path as the incident light energy in the optics assembly and/or from being incident on particular components of the system. For example, FIG. 3 shows an illustrative embodiment that includes a deflection optical element 13 configured to operate on light energy from the one or more optical elements 10a of the optics assembly 10 that is directed toward a build surface 1. The deflection optical element 13 can deflect the incident light energy 14, e.g., one or more laser beams, at a location 16 along the optical path of the incident light energy 14 and at an angle α relative to the direction along which the incident light energy 14 travels when it is incident on the deflection optical element 13. This causes the incident light energy 14 to be directed toward the build surface 1 at an angle relative to the plane of the build surface 1. As a result, a portion of the incident light energy 14 that is reflected by the melt pool 101 will be directed along a reflected light energy path 15 that is at an angle to the incident light energy path 14, e.g., at an angle complementary to the angle at which the incident light energy 14 is oriented relative to the plane of the build surface 1. When the reflected light energy 15 reaches the deflection optical element 13 (assuming the reflected light energy 15 is not incident on another element along the path before reaching the element 13), the reflected light energy 15 will be offset by a distance d from the location 16 where the deflection optical element 13 deflected or otherwise operated on the incident light energy 14. As will be understood, the offset distance d can be a function of a distance between the location 16 where the deflection optical element 13 operates on the incident light energy 14 and the build surface 1 as well as the angle α or an angle of the incident light 14 relative to a plane of the build surface 1. In some cases, the offset distance d can be a function of a distance between the location 16 and the build surface 1 and the angle α or an angle of the incident light 14 relative to a plane of the surface of the melt pool 101. Accordingly, the deflection optical element 13 can be configured (i.e., oriented and/or shaped) so that the incident light energy 14 is deflected at an angle α suitable to achieve a desired offset distance d for a given distance between the deflection optical element 13 and the build surface 1 and/or for a given distance between the deflection optical element 13 and a surface of a melt pool 101 and/or for a direction in which the optics assembly 10 directs the incident light energy 14 relative to the plane of the build surface 1 when the incident light energy 14 is incident on the deflection optical element 13. As mentioned above, the optics assembly 10 can direct light so as to be perpendicular to the build surface 1 when the incident light energy is incident on the deflection optical element 13, or can be arranged at other angles.

A suitable offset distance d can be defined depending on the desired effect on the reflected light energy. For example, if the only concern is to prevent reflected light energy from traveling precisely the same optical path as the incident light energy 14, the offset distance d may be made relatively small, e.g., equal to a cross-sectional size of the incident light energy beam. In some cases, it may be desirable to have the reflected light energy 15 be incident on a particular component designed to absorb or otherwise minimize any effect of the reflected light energy 15 on the system. For example, the reflected light energy 15 can be directed to a beam block 10b or other component, e.g., which can absorb, reflect or otherwise manage the reflected light energy 15 in a desired way. In such a case, the reflected light energy 15 can be offset a desired distance d so the reflected light energy 15 is suitably incident on the light energy managing component. A light absorbing element, beam block or other component 10b that receives the reflected light energy 15 can be located between the deflection optical component 13 and the build surface 1, or can be positioned optically upstream of the deflection optical component 13 (e.g., such that the reflected light energy 15 passes through the deflection optical component 13 on its way to the component 10b). Thus, the deflection optical component 13 can be a terminal component of the optical system such that incident light energy 14 passes through no other optical clement on its way from the deflection optical component 14 to the build surface 1. Alternately, the deflection optical component 14 can be positioned optically upstream of any portions of the optics assembly 10, such as debris shields, beam blocks, lenses, etc., e.g., as shown in FIG. 1. In some cases, a debris shield can include a light absorbing element or other component 10b to manage the reflected light energy 15. For example, the optics assembly 10 can have a debris shield as a terminal component of the optical system, and a deflection optical clement 13 can be positioned optically upstream of the debris shield. Reflected light energy 15 can be received by the debris shield, e.g., a light absorbing and/or reflecting portion of the debris shield. The debris shield can be configured to absorb, reflect or otherwise manage the reflected light energy 15 so that unwanted heating, vaporization, etc. is avoided or otherwise minimized. In some embodiments, the offset distance d can be 5 mm to 30 mm, or any other suitable value such as 10 mm to 25 mm, or more, or less. Similarly, the angle α can be any suitable value determined based on the characteristics discussed above, e.g., can be 1 degree to 8 degrees, 0.5 degrees to 15 degrees, or more, or less. Such offset distance and angle ranges may be suitable for a distance between the deflection optical component 13 to the build surface 1 of 100 mm to 400 mm.

In some embodiments, the deflection optical element 13 can be a static element with an invariable effect on the light energy received from the optics assembly 10. For example, the deflection optical element 13 can be a prism or other refractive element, a diffractive grating or other diffraction element, etc. that is not adjustable in its effect on the incident light energy 14. In some cases, the deflection optical element can be a prism with a planar input surface that receives the incident light energy 14 and a planar output surface that directs the incident light energy toward the build surface. The planar input surface can be arranged at any suitable angle relative to the planar output surface, such as an angle of 1 degree to 10 degrees relative to the planar output surface. In some cases, the prism can be configured so the planar input surface is arranged perpendicular to a direction along which the incident light energy 14 is incident on the planar input surface. Also, in some cases the optics assembly 10 can be arranged to deliver the incident light energy 14 in a direction that is perpendicular to the build surface 1 before being operated on by the deflection optical element 13. In such a case, an angle a at which the deflection optical element 13 deflects the incident light energy 14 may be equal to the angle at which the incident light energy is incident on the build surface 1 and/or an angle at which the reflected light energy 15 is reflected from the build surface 1. However, this is not required in all cases and incident light energy may be incident on the build surface 1 at an angle that is different from the angle a that the deflection optical element deflects the incident light energy.

As noted above, in some embodiments the optics assembly 10 may be configured to scan or otherwise direct one or more laser beams or other incident light energy arrangements in variable directions to selectively illuminate portions of the build surface 1. In such a case, the incident light energy 14 may be incident on the deflection optical component 13 at different angles (i.e., angles relative to the deflection optical element 13 and/or the build surface 1). However, the deflection optical element 13 may be configured such that the angle a at which the incident light energy 14 is deflected will provide a suitable and at least a minimum offset distance d for all possible incidence angles of the incident light on the deflection optical element 13. Also, where the light energy source 11 and optics assembly 10 are configured to produce and direct multiple laser beams or other discrete rays of light energy toward the build surface, one or more deflection optical element 13 may be provided to operate on the multiple beams. In some cases, multiple laser beams may be transmitted to and operated on by a single deflection optical element 13, e.g., where the multiple beams are configured to be incident on the build surface along a line. For example, in some embodiments, incident laser spots on a build surface may be arranged in a line with a long dimension and a short dimension, or in a two-dimensional array. In either case, according to some aspects, a line, or array, of incident laser energy may include multiple individual laser energy pixels arranged adjacent to each other that can have their respective power levels individually controlled. Each laser energy pixel may be turned on or turned off independently and the power of each pixel can be independently controlled. The resulting pixel-based line or array may then be scanned across a build surface to form a desired pattern thereon by controlling the individual pixels during translation of the optics assembly. Such individual laser pixels can be operated on by one or more deflection optical elements 13 to achieve a desired offset distance d, which may be configured to suitably offset reflected light energy to avoid locations where any of the laser beams or spots are operated on by a deflection optical element 13. For example, where the optical assembly 10 is configured to direct a two-dimensional array of laser beams or spots toward a deflection optical element 13 and a build surface, the deflection optical element(s) 13 may operate to cause an offset of reflected light energy 15 in relation to all of the locations where laser beams are deflected by the deflection optical element(s) 13. This can avoid, for example, reflected light energy from one laser beam from traveling a path that is coincident with respect to a different laser beam path. Also, where multiple deflection optical elements 13 are employed, the elements 13 may be arranged in the same, or different, ways, and/or may be oriented in the same, or different, ways. For example, where multiple prisms are employed to deflect incident light energy, the prisms may have the same or different angles between input and output surfaces, the same or different indices of refraction, the same or different orientations (e.g., so light is incident on the prisms at different angles), and so on.

Depending on the particular embodiment, an additive manufacturing system according to the current disclosure may include any suitable number of laser energy sources. For example, in some embodiments, the number of laser energy sources may be at least 5, at least 10, at least 50, at least 100, at least 500, at least 1,000, at least 1,500, or more. In some embodiments, the number of laser energy sources may be less than 2,000, less than 1,500, less than 1,000, less than 500, less than 100, less than 50, or less than 10. Additionally, combinations of the above-noted ranges may be suitable. Ranges both greater and less than those noted above are also contemplated as the disclosure is not so limited.

Additionally, in some embodiments, a power output of a laser energy source (e.g., a laser energy source of a plurality of laser energy sources) may be between about 50 W and about 2,000 W (2 kW). For example, the power output for each laser energy source may be between about 100 W and about 1.5 kW, and/or between about 500 W and about 1 kW. Moreover, a total power output of the plurality of laser energy sources may be between about 500 W (0.5 kW) and about 4,000 kW. For example, the total power output may be between about 1 kW and about 2,000 kW, and/or between about 100 kW and about 1,000 kW. Ranges both greater and less than those noted above are also contemplated as the disclosure is not so limited.

Depending on the embodiment, an array of laser energy pixels (e.g., a line array or a two dimensional array) may have a uniform power density along one or more axes of the array including, for example, along the length dimension (i.e., the longer dimension) of a line array. In other instances, an array can have a non-uniform power density along either of the axes of the array by setting different power output levels for each pixel's associated laser energy source. Moreover, individual pixels on the exterior portions of the array can be selectively turned off or on to produce an array with a shorter length and/or width. In some embodiments, the power levels of the various pixels in an array of laser energy may be independently controlled throughout an additive manufacturing process. For example, the various pixels may be selectively turned off, on, or operated at an intermediate power level to provide a desired power density within different portions of the array.

Generally, laser energy produced by a laser energy source has a power area density. In some embodiments, the power area density of the laser energy transmitted through an optical fiber is greater than or equal to 0.1 W/micrometer², greater than or equal to 0.2 W/micrometer², greater than or equal to 0.5 W/micrometer², greater than or equal to 1 W/micrometer², greater than or equal to 1.5 W/micrometer², greater than or equal to 2 W/micrometer², or greater. In some embodiments, the power area density of the laser energy transmitted through the optical fiber is less than or equal to 3 W/micrometer², less than or equal to 2 W/micrometer², less than or equal to 1.5 W/micrometer², less than or equal to 1 W/micrometer², less than or equal to 0.5 W/micrometer², less than or equal to 0.2 W/micrometer², or less. Combinations of these ranges are possible. For example, in some embodiments, the power area density of the laser energy transmitted through the optical fiber is greater than or equal to 0.1 W/micrometer² and less than or equal to 3 W/micrometer².

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. An optical system for an additive manufacturing apparatus, comprising:
a light energy source configured to provide light energy with a power sufficient to melt a powder material;
a plurality of optical elements configured to receive the light energy from the light energy source and direct the light energy toward a build surface supporting the powder material to melt a portion of the powder material and form a melt pool; and
a deflection optical element configured to operate on the light energy from the plurality of optical elements to deflect the light energy directed toward the build surface at a location and at an angle suitable to cause light energy reflected by the melt pool toward the deflection optical element to be offset from the location.

2. The system of claim 1, wherein the deflection optical element is a static element with an invariable effect on the light energy from the plurality of optical elements.

3. The system of claim 1, wherein the deflection optical element is a prism.

4. The system of claim 1, wherein the deflection optical element is configured to deflect the light energy directed toward the build surface such that light energy reflected by the melt pool is offset by a distance of 5 mm to 30 mm at the location.

5. The system of claim 1, wherein the plurality of optical elements is configured to direct the light energy toward the build surface in a direction perpendicular to the build surface prior to the light energy being deflected by the deflection optical element.

6. The system of claim 5, wherein the deflection optical element is configured to deflect the light energy directed toward the build surface at an angle of 1 degree to 8 degrees.

7. The system of claim 1, wherein the deflection optical element is configured to deflect the light energy directed toward the build surface at an angle of 0.5 degree to 15 degrees.

8. The system of claim 1, wherein the deflection optical element is a prism with a planar input surface that receives the light energy from the plurality of optical elements and a planar output surface that directs the light energy toward the build surface, and wherein the planar input surface is arranged at an angle of 1 degree to 10 degrees relative to the planar output surface.

9. The system of claim 8, wherein the planar input surface is arranged perpendicular to a direction along which the light energy from the plurality of optical elements is incident on the planar input surface.

10. The system of claim 1, wherein the deflection optical element is a terminal optical element of the optical system before the light energy is incident on the build surface.

11. The system of claim 1, wherein the deflection optical element is optically upstream of a debris shield.

12. The system of claim 1, wherein the light energy source and the plurality of optical elements are configured to direct a plurality of laser beams toward the build surface to form a plurality of melt pools, and the deflection optical element is configured to deflect the plurality of laser beams at respective locations and at respective angles suitable to cause light energy reflected by the plurality of melt pools toward the deflection optical element to be offset from the locations.

13. The system of claim 1, wherein the deflection optical element is configured to transmit the reflected light energy through the deflection optical element and toward a light energy absorbing component.

14. The system of claim 1, further comprising a beam block configured to shield the reflected light energy from the plurality of optical elements.

15. A method of managing light energy for an additive manufacturing process, comprising:
providing light energy with a power sufficient to melt a powder material;
using a plurality of optical elements to receive and operate on the light energy to direct the light energy toward a build surface supporting the powder material to melt a portion of the powder material and form a melt pool; and
deflecting the light energy from the plurality of optical elements directed toward the build surface at a location and at an angle suitable to cause light energy reflected by the melt pool toward the plurality of optical elements to be offset from the location.

16. The method of claim 15, wherein deflecting includes using a static element with an invariable effect on the light energy to deflect the light energy from the plurality of optical elements.

17. The method of claim 15, wherein deflecting includes deflecting the light energy directed toward the build surface such that light energy reflected by the melt pool is offset by a distance of 5 mm to 30 mm at the location.

18. The method of claim 15, wherein using a plurality of optical elements includes directing the light energy toward the build surface in a direction perpendicular to the build surface.

19. The method of claim 15, wherein deflecting includes deflecting the light energy directed toward the build surface at an angle of 0.5 degree to 15 degrees.

20. The method of claim 15, wherein deflecting includes receiving the light energy directed toward the build surface at a planar input surface of a prism and outputting the light energy from a planar output surface of the prism toward the build surface, and wherein the planar input surface is arranged at an angle of 1 degree to 10 degrees relative to the planar output surface.

21. The method of claim 15, wherein providing the light energy and using the plurality of optical elements includes directing a plurality of laser beams toward the build surface to form a plurality of melt pools, and deflecting includes deflecting the plurality of laser beams at respective locations and at respective angles suitable to cause light energy reflected by the plurality of melt pools toward the plurality of optical elements to be offset from the locations.

22. The method of claim 15, further comprising using a beam block to shield the reflected light energy from the plurality of optical elements.

23. The method of claim 15, further comprising fusing the powder material with the light energy to form one or more parts on the build surface.

24. A part manufactured using the method of claim 15.
